(19) United States
(12) Patent Application Publication
(10) Pub. No.: US 2026/0119158 A1
(43) Pub. Date: Apr. 30, 2026

(54) METHOD AND APPARATUS FOR GENERATING SERVER LOG, NON-TRANSITORY READABLE STORAGE MEDIUM, AND ELECTRONIC DEVICE

(71) Applicant: SUZHOU METABRAIN INTELLIGENT TECHNOLOGY CO., LTD., Suzhou, Jiangsu (CN)

(72) Inventors: Yuwen ZENG, Suzhou, Jiangsu (CN); Chunfen ZHOU, Suzhou, Jiangsu (CN); Binghui ZHANG, Suzhou, Jiangsu (CN)

(21) Appl. No.: 19/142,938

(22) PCT Filed: Sep. 27, 2024
(86) PCT No.: PCT/CN2024/121988

§ 371 Date: Jun. 24, 2025

(30) Foreign Application Priority Data
Nov. 29, 2023 (CN) 202311615385.8

(51) Int. Cl. G06F 8/65

(52) U.S. Cl. CPC G06F 8/65

(57) ABSTRACT

Embodiments of the present application provide a method and apparatus for generating a server log, a non-transitory readable storage medium and an electronic device. The method includes: in response to starting to update target firmware in a server from a first version to a second version by a target program in an operating system of the server, acquiring first version information of the target firmware, and sending update start information to a baseboard management controller (BMC) of the server; in response to the target firmware being completely updated from the first version to the second version by the target program, acquiring second version information of the target firmware, and sending update end information to the BMC. Through the present application, it solves the problem of BMC being unable to record version information of firmware in the log when updating the firmware in the server by the target program in the operating system of the server.

### CROSS-REFERENCE TO RELATED APPLICATION

The present application claims the priority of the Chinese Patent application filed on Nov. 29, 2023 before the CNIPA, China National Intellectual Property Administration with the application number of 202311615385.8, and the title of “METHOD AND APPARATUS FOR GENERATING SERVER LOG, STORAGE MEDIUM AND ELECTRONIC DEVICE”, which is incorporated herein in its entirety by reference.

### FIELD

The present application relates to the field of computers and more particularly, to a method and apparatus for generating a server log, a non-transitory readable storage medium and an electronic device.

### BACKGROUND

In related art, when updating firmware of a server by a baseboard management controller (BMC), BMC may record version changes of the firmware. However, when the firmware in the server is not updated by the BMC, for example, when updating the firmware in the server by an update tool in the operating system of the server, because the process of updating the firmware in the server is performed in the operating system of the server, and not by the BMC, so that the BMC is not aware of this. It may be understood that the BMC is unable to obtain related information and record it in the log.

### SUMMARY

Embodiments of the present application provide a method and apparatus for generating a server log, a non-transitory readable storage medium and an electronic device, to at least solve the problem in the related art that the BMC is unable to record version information of the firmware in the logs when updating the firmware in the server by the target program in the operating system of the server.

According to the first aspect of the embodiments of the present application, a method for generating a server log is provided, including: in response to starting to update target firmware in a server from a first version to a second version by a target program in an operating system of the server, acquiring first version information of the target firmware, and sending update start information to a baseboard management controller (BMC) of the server, wherein the update start information includes the first version information, the first version information is description information of the first version, and the BMC is configured to record received update start information in a target log; and in response to the target firmware being completely updated from the first version to the second version by the target program, acquiring second version information of the target firmware, and sending update end information to the BMC, wherein the update end information includes the second version information, the second version information is description information of the second version, and the BMC is configured to record received update end information in the target log.

In an exemplary embodiment, in response to starting to update target firmware in a server from a first version to a second version by a target program in an operating system of the server, acquiring first version information of the target firmware, and sending update start information to a baseboard management controller (BMC) of the server, includes: executing a first function that is preset in response to starting to update the target firmware in the server from the first version to the second version by the target program, wherein the first function is used for acquiring the first version information of the target firmware, and sending the update start information to the BMC.

In an exemplary embodiment, the executing the first function that is preset in response to starting to update the target firmware in the server from the first version to the second version by the target program includes: executing, by the target firmware, the first function in response to starting to update the target firmware in the server from the first version to the second version by the target program, to acquire the first version information of the target firmware, and send the update start information to the BMC.

In an exemplary embodiment, the executing, by the target firmware, the first function in response to starting to update the target firmware in the server from the first version to the second version by the target program includes: in response to starting to update the target firmware in the server from the first version to the second version by the target program, switching the operating system from a running state to a paused running state, switching the target firmware from the paused running state to the running state, and executing the first function by the target firmware.

In an exemplary embodiment, the executing, by the target firmware, the first function in response to starting to update the target firmware in the server from the first version to the second version by the target program includes: in response to starting to update the target firmware in the server from the first version to the second version by the target program, triggering a target interruption, and executing the first function by the target firmware, wherein the first function is a function that is triggered to execute after the target interruption is triggered.

In an exemplary embodiment, the executing, by the target firmware, the first function includes: in response to the first version of the target firmware being copied from a first storage space to a second storage space, executing the first function by the first version of the target firmware stored in the second space, wherein the second storage space is a storage space in a memory of the server, the first function is used for reading the first version information from the first storage space and sending the update start information to the BMC, the first storage space is used for storing the first function, a current version of the target firmware and current version information of the target firmware; and when the current version of the target firmware is the first version, the current version information is the first version information.

In an exemplary embodiment, the executing the first function that is preset includes: executing a first part of a code of the first function, wherein the first part of the code is used for reading the first version information from the first storage space, the first storage space is used for storing a current version of the target firmware and current version information of the target firmware; when the current version of the target firmware is the first version, the current version information is the first version information; and executing a second part of the code of the first function, wherein the second part of the code is used for sending the update start information to the BMC.

In an exemplary embodiment, before executing the first function that is preset, the method further includes: in response to the first version information being version information of an initial version of the target firmware, storing the first version information in the first storage space; or in response to the target firmware being completely updated from a third version to the first version by the target program, updating the current version information stored in the first storage space from third version information to the first version information, wherein the third version information is description information of the third version.

In an exemplary embodiment, the executing the first function that is preset includes: executing the first function stored in a first storage space, wherein the first function is used for reading the first version information from the first storage space and sending the update start information to the BMC, the first storage space is used for storing the first function, a current version of the target firmware and current version information of the target firmware; and when the current version of the target firmware is the first version, the current version information is the first version information; or in response to the first function being copied from the first storage space to a second storage space, executing the first function stored in the second storage space, wherein the second storage space is a storage space in a memory of the server, the first function is used for reading the first version information from the first storage space and sending the update start information to the BMC, the first storage space is used for storing the first function, the current version of the target firmware and the current version information of the target firmware; and when the current version of the target firmware is the first version, the current version information is the first version information.

In an exemplary embodiment, the sending the update start information to the baseboard management controller (BMC) of the server includes: invoking a target interface to send the update start information to the BMC.

In an exemplary embodiment, the sending the update start information to the baseboard management controller (BMC) of the server includes: sending the update start information to the BMC, wherein the update start information further includes first state information, and the first state information is used for indicating start of updating the target firmware.

In an exemplary embodiment, before in response to the target firmware being completely updated from the first version to the second version by the target program, acquiring the second version information of the target firmware, and sending the update end information to the BMC, the method further includes: after sending the update start information to the BMC, switching the target firmware from the running state to the paused running state, switching the operating system from the paused running state to the running state, continuing to update the target firmware from the first version to the second version by the target program.

In an exemplary embodiment, in response to the target firmware being completely updated from the first version to the second version by the target program, acquiring second version information of the target firmware, and sending update end information to the BMC, includes: executing a second function that is preset in response to the target firmware being completely updated from the first version to the second version by the target program, wherein the second function is used for acquiring the second version information of the target firmware, and sending the update end information to the BMC.

In an exemplary embodiment, executing the second function that is preset in response to the target firmware being completely updated from the first version to the second version by the target program includes:
executing, by the target firmware, the second function in response to the target firmware being completely updated from the first version to the second version by the target program, to acquire the second version information of the target firmware, and send the update end information to the BMC.

In an exemplary embodiment, executing, by the target firmware, the second function in response to the target firmware being completely updated from the first version to the second version by the target program, includes: in response to the target firmware being completely updated from the first version to the second version by the target program, switching the operating system from a running state to a paused running state, switching the target firmware from the paused running state to the running state, and executing the second function by the target firmware.

In an exemplary embodiment, executing, by the target firmware, the second function in response to the target firmware being completely updated from the first version to the second version by the target program, includes: in response to the target firmware being completely updated from the first version to the second version by the target program, triggering a target interruption, and executing the second function by the target firmware, wherein the second function is a function that is triggered to execute after the target interruption is triggered.

In an exemplary embodiment, the executing, by the target firmware, the second function includes: in response to the first version of the target firmware being copied from a first storage space to a second storage space, executing the second function by the first version of the target firmware stored in the second storage space, wherein the second storage space is a storage space in a memory of the server, the second function is used for reading the second version information from the first storage space and sending the update end information to the BMC, the first storage space is used for storing the second function, a current version of the target firmware and current version information of the target firmware; and when the current version of the target firmware is the second version, the current version information is the second version information.

In an exemplary embodiment, the executing the second function that is preset includes: executing a third part of a code of the second function, wherein the third part of the code of the second function is used for reading the second version information from the first storage space, the first storage space is used for storing a current version of the target firmware and current version information of the target firmware; when the current version of the target firmware is the second version, the current version information is the second version information; and executing a fourth part of the code of the second function, wherein the fourth part of the code of the second function is used for sending the update end information to the BMC.

In an exemplary embodiment, the executing the second function that is preset includes: executing the second function stored in a first storage space, wherein the second function is used for reading the second version information from the first storage space and sending the update end information to the BMC, the first storage space is used for storing the second function, a current version of the target firmware and current version information of the target firmware; and when the current version of the target firmware is the second version, the current version information is the second version information; or in response to the second function being copied from the first storage space to a second storage space, executing the second function stored in the second storage space, wherein the second storage space is a storage space in a memory of the server, the second function is used for reading the second version information from the first storage space and sending the update end information to the BMC, the first storage space is used for storing the second function, the current version of the target firmware and the current version information of the target firmware; and when the current version of the target firmware is the second version, the current version information is the second version information.

In an exemplary embodiment, further including: in response to the target firmware being completely updated from the first version to the second version by the target program, updating the current version information stored in the first storage space from the first version information to the second version information, wherein when the current version of the target firmware is the second version, the current version information is the second version information.

In an exemplary embodiment, the sending the update end information to the BMC, includes: invoking a target interface to send the update end information to the BMC.

In an exemplary embodiment, the sending the update end information to the BMC, includes: sending the update end information to the BMC, wherein the update end information further includes second state information, and the second state information is used for indicating completion of updating the target firmware.

In an exemplary embodiment, the target firmware includes at least one of the following: a basic input output system (BIOS), a complex programmable logic device (CPLD), a field replaceable unit (FRU), and a power management device.

According to the second aspect of the embodiments of the present application, a method for generating a server log is provided, including: in response to starting to update target firmware in a server from a first version to a second version by a target program in an operating system of the server, receiving update start information sent by the target firmware, and recording received update start information in a target log, wherein the update start information includes first version information, the first version information is description information of the first version, the first version information is version information obtained from a first storage space by executing a first function that is preset, the first storage space is configured to store the first function and a second function that is preset; and when starting to update the target firmware from the first version to the second version, the first storage space is further configured to store the first version and the first version information of the target firmware; and in response to the target firmware being completely updated from the first version to the second version by the target program, receiving update end information sent by the target firmware, and recording received update end information in the target log, wherein the update end information includes second version information, the second version information is description information of the second version, the second version information is version information obtained from the first storage space by executing the second function that is preset; and when the target firmware is completely updated from the first version to the second version, the first storage space is further configured to store the second version and the second version information of the target firmware, the second version of the target firmware is configured to replace the first version of the target firmware stored in the first storage space, and the second version information is used for replacing the first version information stored in the first storage space.

In an exemplary embodiment, the update start information further includes first state information, the first state information is used for indicating start of updating the target firmware; the update end information further includes second state information, and the second state information is used for indicating completion of updating the target firmware.

According to the third aspect of the embodiments of the present application, an apparatus for generating a server log is provided, including: a first acquisition module configured for, in response to starting to update target firmware in a server from a first version to a second version by a target program in an operating system of the server, acquiring first version information of the target firmware, and sending update start information to a baseboard management controller (BMC) of the server, wherein the update start information includes the first version information, the first version information is description information of the first version, and the BMC is configured to record received update start information in a target log; and a second acquisition module configured for, in response to the target firmware being completely updated from the first version to the second version by the target program, acquiring second version information of the target firmware, and sending update end information to the BMC, wherein the update end information includes the second version information, the second version information is description information of the second version, and the BMC is configured to record received update end information in the target log.

According to the fourth aspect of the embodiments of the present application, an apparatus for generating a server log is provided, including: a first receiving module configured for, in response to starting to update target firmware in a server from a first version to a second version by a target program in an operating system of the server, receiving update start information sent by the target firmware, and recording received update start information in a target log, wherein the update start information includes first version information, the first version information is description information of the first version, the first version information is version information obtained from a first storage space by executing a first function that is preset, the first storage space is configured to store the first function and a second function that is preset; and when starting to update the target firmware from the first version to the second version, the first storage space is further configured to store the first version and the first version information of the target firmware; and a second receiving module configured for, in response to the target firmware being completely updated from the first version to the second version by the target program, receiving update end information sent by the target firmware, and recording received update end information in the target log, wherein the update end information includes second version information, the second version information is description information of the second version, the second version information is version information obtained from the first storage space by executing the second function that is preset; and when the target firmware is completely updated from the first version to the second version, the first storage space is further configured to store the second version and the second version information of the target firmware, the second version of the target firmware is configured to replace the first version of the target firmware stored in the first storage space, and the second version information is used for replacing the first version information stored in the first storage space.

According to the fifth aspect of the embodiments of the present application, a non-transitory computer-readable storage is provided, wherein the non-transitory computer-readable storage medium stores a computer program, the computer program, when executed by a processor, implements the steps of the method according to any one of the above embodiments.

According to the sixth aspect of the embodiments of the present application, an electronic device is provided, including a memory, a processor, and a computer program stored on the memory and executable on the processor, wherein the computer program, when executed by the processor, implements the steps of the method according to any one of the above embodiments.

Through the present application, when starting to update the firmware in the server by tools in the operating system of the server, it may obtain the first version information of the firmware before the update, and send the update start information carrying the first version information to the BMC, but is not limited to it. And when the firmware in the server is completely updated by the tools in the operating system of the server, it may obtain the second version information of the firmware after the update, and send the update end information carrying the second version information to the BMC, but is not limited to it. In this way, it is achieved to send the update start information and update end information to the BMC when updating the firmware in the server by the tools in the operating system of the server, the BMC records the update start information and update end information in the log. Therefore, it may solve the problem of the BMC being unable to record the version information of the firmware in the log when updating the firmware in the server by the target program in the operating system of the server. This achieves the technical effect of the BMC being able to record the version information of the firmware in the log when updating the firmware in the server by the target program in the operating system of the server.

### BRIEF DESCRIPTION OF THE DRAWINGS

FIG. 1 is an architecture diagram of a server to which a method for generating a server log is applied according to an embodiment of the present application;

FIG. 2 is a schematic diagram of an application scenario of a method for generating a server log according to an embodiment of the present application;

FIG. 3 is a first flow chart of a method for generating a server log according to the embodiment of the present application;

FIG. 4 is a first schematic diagram of an example for executing a first function according to an embodiment of the present application;

FIG. 5 is a schematic diagram of an example for storing first version information in a first storage space according to an embodiment of the present application;

FIG. 6 is a second schematic diagram of an example for executing a first function according to an embodiment of the present application;

FIG. 7 is a first schematic diagram of an example for executing a second function according to an embodiment of the present application;

FIG. 8 is a second schematic diagram of an example for executing a second function according to an embodiment of the present application;

FIG. 9 is a second flow chart of a method for generating a server log according to an embodiment of the present application;

FIG. 10 is a schematic diagram of a method for generating a server log according to an embodiment of the present application;

FIG. 11 is a sequence diagram of a method for generating a server log according to an embodiment of the present application; and

FIG. 12 is a structural block diagram of an apparatus for generating a server log according to an embodiment of the present application.

### DETAILED DESCRIPTION

In the following text, the embodiments of the present application will be described in detail with reference to the accompanying drawings and in combination with the embodiments.

It should be noted that the terms “first”, “second”, etc. in the specification and claims of the present application, as well as in the accompanying drawings, are used to distinguish similar objects and do not necessarily need to be used to describe a specific order or sequence.

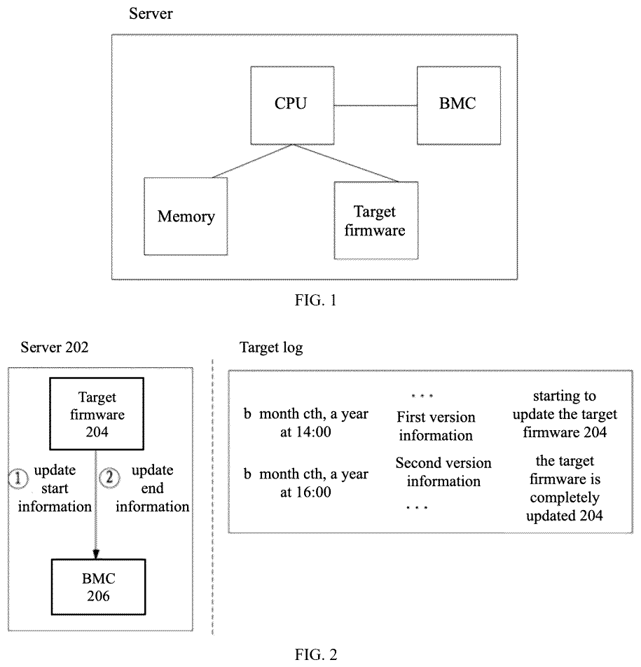

The method embodiments provided in the present application may be executed in server devices or similar computing devices. Taking running on a server device as an example, FIG. 1 is an architecture diagram of a server to which a method for generating a server log is applied according to an embodiment of the present application. The server may be deployed with target firmware, but is not limited to it, as shown in FIG. 1, the server may be deployed with a central processing unit (CPU), the target firmware, a memory, and the BMC, but is not limited to it. Communication connections are established between the CPU, the target firmware, and the memory, as well as between the CPU and the BMC. The BMC can establish communication connections between the CPU and the target firmware, but is not limited to it. The BMC is an independent management controller located on the server motherboard, with remote management, monitoring, and control functions. For example, it can generate a target log in the BMC when updating the target firmware in the server, but is not limited to it, and record the update state of the target firmware in the target log, such as the version information before updating the target firmware, the version information after updating the target firmware, and so on.

Firstly, the English abbreviations used in the embodiments of the present application are explained as follows:
BIOS: Basic Input Output System, used to boot the system of the server.
BMC: Baseboard Management Controller.
SEL: System Event Log.
SMI: System Management Interrupt.
SMM: System Management Mode.
IPMI: Intelligent Platform Management Interface.
FLASH: Flash EEPROM Memory, a non-transitory storage device.

In order to better understand the method for generating the server log in the embodiments of the present application, the application scenarios of the method for generating a server log in the embodiments of the present application are explained and illustrated below in conjunction with some embodiments, which may be applicable but is not limited to the embodiments of the present application.

FIG. 2 is a schematic diagram of an application scenario of a method for generating a server log according to an embodiment of the present application. As shown in FIG. 2, the target firmware 204 and the baseboard management controller (BMC) 206 are deployed on the server 202. When starting to update the target firmware in the server from the first version to the second version by the target program in the operating system of the server, the changes in the version information of the target firmware 204 may be recorded in the target log through the following steps, but are not limited to:
Step S202: in response to starting to update target firmware 204 in a server 202 from a first version to a second version by a target program in an operating system of the server 202, acquiring first version information of the target firmware 204, and sending update start information to a baseboard management controller (BMC) 206 of the server 202, wherein the update start information includes the first version information, the first version information is description information of the first version, and the BMC 206 is configured to record received update start information in a target log.
Step S204: in response to the target firmware being completely updated from the first version to the second version by the target program, acquiring second version information of the target firmware, and sending update end information to the BMC, wherein the update end information includes the second version information, the second version information is description information of the second version, and the BMC is configured to record received update end information in the target log.

As an example, the BMC 206 may record b month cth, a year at 14:00, the first version information of the target firmware 204 and the start of updating the target firmware 204 in the target log when receiving the update start information, but is not limited to it. And the BMC 206 may record b month cth, a year at 16:00, the second version information of the target firmware 204 and the completion of updating the target firmware 204 in the target log when receiving the update end information, but is not limited to it.

For example, in response to updating the firmware in the server by the BMC, the BMC may record the corresponding version information in the log. When starting to update, it is recorded in the log as: b month cth, a year at 14:00, a current firmware version number is 2.0, and the update is started. When the update is completed, it is recorded in the log as: b month cth, a year at 18:00, the current firmware version number is 3.0, the version is upgraded, and the update is completed.

In this way, when updating the version of the target firmware in the server by the target program in the operating system of the server, it achieves that the BMC may timely record the update state of the target firmware in the log. When the system encounters abnormalities or failures, administrators may understand the update process and results of the target firmware by reviewing the logs, discover problems in a timely manner, and better handle faults and abnormal situations, thus improving the stability and reliability of the system.

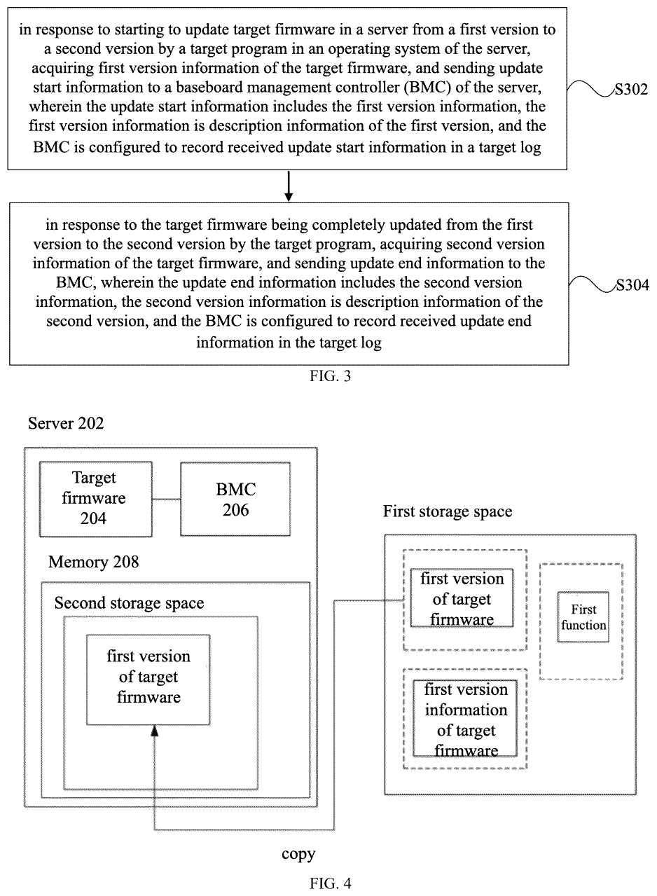

In this embodiment, a method for generating a server log is provided. FIG. 3 is a first flow chart of the method for generating the server log according to the embodiment of the present application. As shown in FIG. 3, the flow chart includes the following steps:
Step S302: in response to starting to update target firmware in a server from a first version to a second version by a target program in an operating system of the server, acquiring first version information of the target firmware, and sending update start information to a baseboard management controller (BMC) of the server, wherein the update start information includes the first version information, the first version information is description information of the first version, and the BMC is configured to record received update start information in a target log;
Step S304: in response to the target firmware being completely updated from the first version to the second version by the target program, acquiring second version information of the target firmware, and sending update end information to the BMC, wherein the update end information includes the second version information, the second version information is description information of the second version, and the BMC is configured to record received update end information in the target log.

Through the above steps, when starting to update the firmware in the server by tools in the operating system of the server, it may obtain the first version information of the firmware before the update, and send the update start information carrying the first version information to the BMC, but is not limited to it. And when the firmware in the server is completely updated by the tools in the operating system of the server, it may obtain the second version information of the firmware after the update, and send the update end information carrying the second version information to the BMC, but is not limited to it. In this way, it is achieved to send the update start information and update end information to the BMC when updating the firmware in the server by the tools in the operating system of the server, the BMC records the update start information and update end information in the log. Therefore, it may solve the problem of the BMC being unable to record the version information of the firmware in the log when updating the firmware in the server by the target program in the operating system of the server. This achieves the technical effect of the BMC being able to record the version information of the firmware in the log when updating the firmware in the server by the target program in the operating system of the server.

Among them, the executing entity of the above steps may be the server or the like, but is not limited to this.

In the technical solution provided in the step 302 above, the BMC is an independent management controller located on the server motherboard, with remote management, monitoring, and control functions. SEL (System Event Log, also known as target log) is one of the functions of the BMC to record system events. In order to provide tracking and analysis capabilities for important events that occur in server systems, various system events such as hardware errors, power status changes, sensor alarms, etc. are recorded. By monitoring and analyzing SEL logs, administrators may better understand the health status of the system, identify problems in a timely manner, handle faults and abnormal situations, and improve the stability and reliability of the system. Meanwhile, SEL logs also provide important reference for troubleshooting and maintenance, helping the administrators locate and solve problems.

Recording the firmware version number and its change logs is an important part of SEL, and its significance includes the following points. 1. Tracking issues and troubleshooting: SEL records system events and status changes, including information related to firmware updates. When the system encounters abnormalities or malfunctions, the administrators may understand the process and results of firmware updates by reviewing the SEL logs, thereby better tracking issues and troubleshooting. 2. Maintaining historical records: SEL provides a history record of system maintenance by recording BIOS version numbers and related events. The administrators may view SEL logs when needed to understand the history record of the system maintenance. The administrators may view SEL logs when needed to understand the time, content, and results of the system maintenance, providing reference for subsequent maintenance work. 3. Security Checks: detailed information about each firmware update is recorded in the SEL logs, including the update time, date, version number, etc. This is crucial for security checks to ensure the legality and integrity of firmware updates, and to prevent unauthorized tampering or malicious operations. 4. Remote management and monitoring: the BMC typically supports remote management and monitoring functions. By generating the SEL logs, the BMC may transmit related information of firmware update to remote management terminals, and the administrators may view and analyze the SEL logs from remote locations, thus achieving centralized management and monitoring of multiple servers.

In summary, the BMC records the firmware version numbers and generates the SEL logs to help with tracking issues and troubleshooting, it may provide history records of system maintenance, strengthen security checks, and support the remote management and monitoring functions. These advantages may improve the efficiency and reliability of system management, providing administrators with more convenient management methods. Therefore, it is necessary to record the firmware version number and generate the SEL logs by the BMC.

It may update the target firmware in the server by the BMC, but is not limited to it. In this case, the BMC may record the firmware version changes in the log. For example, when updating the BIOS (Basic Input/Output System) firmware of the server by the BMC, the BMC may update the pre encrypted and packaged BIOS hpm file and monitor its update process, but is not limited to it. Firstly, create a configuration file with a suffix of. conf, and the configuration file includes device information, manufacturer information, product information, a firmware major version number, a firmware minor version number, a motherboard ID (Identity document), and other configuration information. Secondly, integrate and encrypt the compiled BIOS bin file with the configuration file into an hpm file for the BMC to use when updating. Finally, when the BMC updates the BIOS hpm file, it parses the configuration file to obtain the firmware major version number and the firmware minor version number, integrates them to obtain the BIOS version number, and generates corresponding SEL records through pre agreed IPMI commands to achieve management and control of the version number during BIOS upgrades.

But when updating the firmware in the server by the target program in the operating system of the server, the BMC is unable to know that the firmware in the server has been updated, resulting in the BMC being unable to record the update state of the firmware in the log. In order to record firmware version changes in the log when updating the server firmware is not performed by the BMC, it may obtain the first version information of the target firmware and send the update start information to the baseboard management controller BMC of the server, in response to starting to update the target firmware in the server from the first version to the second version by the target program in the operating system of the server, but is not limited to it.

In this embodiment, the target program may include, but is not limited to, target applications or target software of update tools. The first version is the current version of the target firmware, and the second version is the version of the target firmware to be updated to. The second version may be lower than the first version, for example, it is a downgrade of the version of the target firmware, or the second version may be higher than the first version, for example, it is an upgrade of the version of the target firmware, or the second version may be the same as the first version, for example, it is a refresh of the version of the target firmware.

In this embodiment, the first version information is the description information of the first version, which may include but is not limited to the version number, version size, and version source of the first version. For example, the version number of the first version is V2.1, the version size is 30M (Mega), and the version source is software 1. The version number of the first version may include, but is not limited to, the major version number and the minor version number. For example, the major version number of the first version is 2 in V2.1, and the minor version number of the first version is 1 in V2.1.

In this embodiment, the BMC may record the received update start information in the target log, but is not limited to it. For example, in response to starting to update the firmware in the server by the target program in the operating system of the server, the BMC records in the log as: b month cth, a year at 14:00, the firmware version number is V2.0, and the update is started.

In an exemplary embodiment, it may be performed, but is not limited to, through the following method to acquire the first version information of the target firmware and send the update start information to the baseboard management controller (BMC) of the server in response to starting to update the target firmware in the server from the first version to the second version by the target program in the operating system of the server: executing a first function that is preset in response to starting to update the target firmware in the server from the first version to the second version by the target program, wherein the first function is used for acquiring the first version information of the target firmware, and sending the update start information to the BMC.

In this embodiment, the first function that is preset may be, but is not limited to, a function of target type. As an example, the function of target type may include, but is not limited to, a function of SMM module type.

In this embodiment, the first function may be used, but is not limited to, to obtain the first version information of the target firmware and send the update start information to the BMC, enabling the BMC to receive the first version information of the target firmware before the update in a timely manner when starting to update the target firmware in the server from the first version to the second version by the target program in the operating system of the server.

In an exemplary embodiment, it may be performed, but is not limited to, through the following method to execute the first function that is preset in response to starting to update the target firmware in the server from the first version to the second version by the target program: executing, by the target firmware, the first function in response to starting to update the target firmware in the server from the first version to the second version by the target program, to acquire the first version information of the target firmware, and send the update start information to the BMC.

In this embodiment, when starting to update the target firmware in the server from the first version to the second version by the target program, the first function may be executed by the target firmware, but is not limited to this, to obtain the first version information of the target firmware and send the update start information to the BMC.

In an exemplary embodiment, it may be performed, but is not limited to, through the following method to the execute, by the target firmware, the first function in response to starting to update the target firmware in the server from the first version to the second version by the target program, including: in response to starting to update the target firmware in the server from the first version to the second version by the target program, switching the operating system from a running state to a paused running state, switching the target firmware from the paused running state to the running state, and executing the first function by the target firmware.

In this embodiment, the operating system of the server and the target firmware may run in series, but are not limited to this. It may be understood that the operating system of the server and the target firmware cannot run simultaneously. In this case, it may switch the operating system of the server from the running state to the paused running state, but is not limited to it, for example, the operating system of the server is switched from running to paused running, the target firmware may be switched from the paused running state to the running state, for example, the target firmware is switched from paused running to running, and the first function is executed by the target firmware.

In an exemplary embodiment, it may be performed, but is not limited to, through the following method to execute, by the target firmware, the first function in response to starting to update the target firmware in the server from the first version to the second version by the target program, including: in response to starting to update the target firmware in the server from the first version to the second version by the target program, triggering a target interruption, and executing the first function by the target firmware, wherein the first function is a function that is triggered to execute after the target interruption is triggered.

In this embodiment, the target interrupt may be used, but is not limited to, to transfer control power from the operating system of the server to the target firmware. It may be understood that the target interrupt may be used, to switch the operating system of the server from the running state to the paused running state, and to switch the target firmware from the paused running state to the running state, but is not limited to this. The target interrupt may include but is not limited to a SMI interrupt.

For example, when starting to update the target firmware in the server from the first version to the second version by the target program (such as starting to update from version 1.02 to version 1.03), it may trigger the SMI interrupt to enter a SMM mode, but is not limited to it, and at this point, the control power will be transferred from the OS (Operating System) to the target firmware. The target firmware executes the first SMM module function (also known as the first function).

In an exemplary embodiment, it may be performed, but is not limited to, through the following method to execute, by the target firmware, the first function: in response to the first version of the target firmware being copied from a first storage space to a second storage space, executing the first function by the first version of the target firmware stored in the second storage space, wherein the second storage space is a storage space in a memory of the server, the first function is used for reading the first version information from the first storage space and sending the update start information to the BMC, the first storage space is used for storing the first function, a current version of the target firmware and current version information of the target firmware; and when the current version of the target firmware is the first version, the current version information is the first version information.

In this embodiment, the target firmware may include, but is not limited to, a set of solidified programs or code, and the version of the target firmware may include, but is not limited to, a certain version of the program or code. For example, the first version of the target firmware may include, but is not limited to, the program or code of the first version, and the second version of the target firmware may include, but is not limited to, the program or code of the second version.

In this embodiment, in order to improve the efficiency, in response to starting to update the target firmware in the server from the first version to the second version by the target program, it may include, but is not limited to, copying the first version of the target firmware stored in the first storage space to the second storage space. The first storage space may include, but is not limited to, the storage space in the hard disk where the target firmware is fixed, such as Flash devices, etc. The first storage space may store, but is not limited to, the current version information of the target firmware, the current version of the target firmware, and the first function. For example, the storage space corresponding to 0x20FF0 to 0x20FFF in the Flash device is the storage space used to store the current version information of the target firmware.

FIG. 4 is a first schematic diagram of an example for executing the first function according to an embodiment of the present application. As shown in FIG. 4, the target firmware 204, the BMC (Baseboard Management Controller) 206, and the memory 208 are deployed on the server 202, and the second storage space is deployed in the memory 208. The first storage space is used to store the first function, the current version of the target firmware, and the current version information of the target firmware. When the current version of the target firmware is the first version, the current version information is the first version information.

It may execute the first function by the first version of the target firmware stored in the second storage space when the first version of the target firmware is copied from the first storage space to the second storage space, but is not limited to it. For example, its operation is to obtain information at positions from 0x20FF0 to 0x20FFF in the first storage space through a way of read-write IO interface.

In an exemplary embodiment, it may be performed, but is not limited to, through the following method to execute the first function that is preset: executing a first part of a code of the first function, wherein the first part of the code is used for reading the first version information from the first storage space, the first storage space is used for storing a current version of the target firmware and current version information of the target firmware; when the current version of the target firmware is the first version, the current version information is the first version information; and executing a second part of the code of the first function, wherein the second part of the code is used for sending the update start information to the BMC.

In this embodiment, the first function may include, but is not limited to, two parts of the code. The first part of the code may be used, but is not limited to, to read the first version information from the first storage space, such as the version number, version size, and version source of the first version. The second part of the code can send the update start information carrying the first version information to the BMC, but is not limited to it.

In an exemplary embodiment, before executing the first function that is preset, the above method further includes: in response to the first version information being version information of an initial version of the target firmware, storing the first version information in the first storage space; or in response to the target firmware being completely updated from a third version to the first version by the target program, updating the current version information stored in the first storage space from third version information to the first version information, wherein the third version information is description information of the third version.

In this embodiment, the first version information may be the version information of the initial version of the target firmware, for example, the first version information may be the version information of the default version of the target firmware. In this case, the first version information may be stored in the first storage space, but is not limited to this.

In this embodiment, the first version information may not be the version information of the initial version of the target firmware. It may be understood that the first version information is not the version information of the default version of the target firmware. For example, in response to the target firmware being completely updated from the third version to the first version by the target program, the third version information stored in the first storage space may be updated to the first version information, but ios not limited to this.

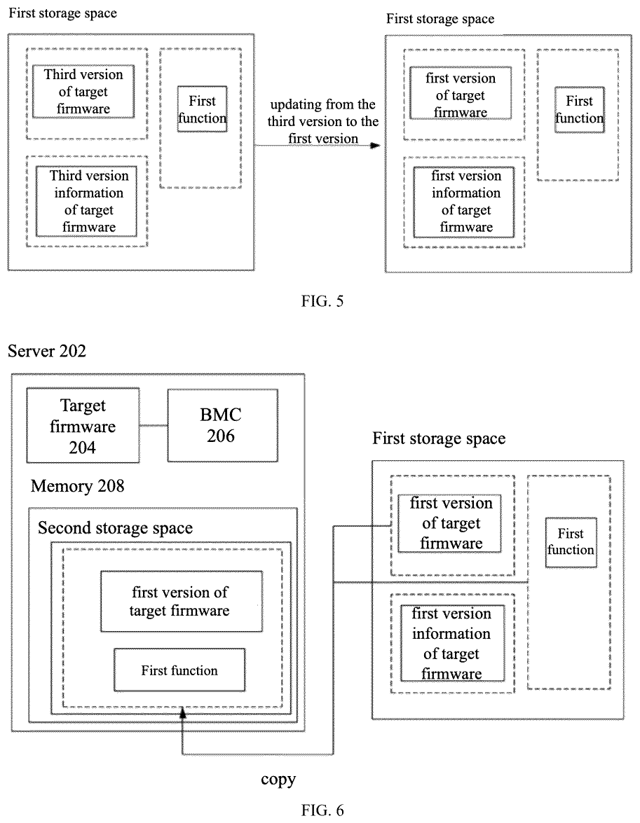

FIG. 5 is a schematic diagram of an example for storing the first version information in the first storage space according to an embodiment of the present application. As shown in FIG. 5, before updating the target firmware from the third version to the first version by the target program, the first storage space stores the third version of the target firmware, the third version information of the target firmware and the first function. In response to the target firmware being completely updated from the third version to the first version by the target program, the third version information stored in the first storage space is updated to the first version information. In this case, the first storage space stores the first version of the target firmware, the first version information of the target firmware, and the first function.

In an exemplary embodiment, it may be performed, but is not limited to, through the following method to execute the first function that is preset: executing the first function stored in a first storage space, wherein the first function is used for reading the first version information from the first storage space and sending the update start information to the BMC, the first storage space is used for storing the first function, a current version of the target firmware and current version information of the target firmware; and when the current version of the target firmware is the first version, the current version information is the first version information; or in response to the first function being copied from the first storage space to a second storage space, executing the first function stored in the second storage space, wherein the second storage space is a storage space in a memory of the server, the first function is used for reading the first version information from the first storage space and sending the update start information to the BMC, the first storage space is used for storing the first function, the current version of the target firmware and the current version information of the target firmware; and when the current version of the target firmware is the first version, the current version information is the first version information.

In this embodiment, the first function stored in the second storage space can be executed by the first version of the target firmware in the second storage space, but is not limited to it, as shown in FIG. 4. Only the current version (e.g., the first version) of the target firmware is copied to the second storage space, and then the first function stored in the first storage space is executed by the first version of the target firmware in the second storage space. In this way, the storage space of the memory occupied by the first function is reduced, and the utilization of the storage space of the memory is improved.

In this embodiment, FIG. 6 is a second schematic diagram of an example for executing the first function according to the embodiment of the present application. As shown in FIG. 6, the target firmware 204, the BMC (Baseboard Management Controller) 206, and the memory 208 are deployed on the server 202, and a second storage space is deployed in the memory 208. The first storage space is used for storing the first function, the current version of the target firmware, and the current version information of the target firmware. When the current version of the target firmware is the first version, the current version information is the first version information.

When the current version (e.g., first version) of the target firmware and the first function are copied from the first storage space to the second storage space, the first function stored in the second storage space can be executed by the current version (e.g., first version) of the target firmware in the second storage space but is not limited to it. In this way, the time required for the current version of the target firmware in the second storage space to execute the first function stored in the first storage space is saved, and the efficiency of executing functions in the memory is improved.

In an exemplary embodiment, it may be performed, but is not limited to, through the following method to send the update start information to the baseboard management controller (BMC) of the server: invoking a target interface to send the update start information to the BMC.

In this embodiment, the target interface is an interface between the BMC and the target firmware. For example, the target interface is an interface that meets the target protocol. As an example, the target interface may include but is not limited to an interface that meets the IPMI protocol.

In an exemplary embodiment, it may be performed, but is not limited to, through the following method to send the update start information to the baseboard management controller (BMC) of the server: sending the update start information to the BMC, wherein the update start information further includes first state information, and the first state information is used for indicating start of updating the target firmware.

In this embodiment, the first state information may be fixed in the first function, but is not limited to it. It may be understood that in response to triggering the execution of the first function after triggering the target interrupt, it may indicate the start of updating the target firmware.

In an exemplary embodiment, before in response to the target firmware being completely updated from the first version to the second version by the target program, acquiring the second version information of the target firmware, and sending the update end information to the BMC, the method further includes: after sending the update start information to the BMC, switching the target firmware from the running state to the paused running state, switching the operating system from the paused running state to the running state, continuing to update the target firmware from the first version to the second version by the target program.

In this embodiment, after sending the update start information to the BMC, there is no need to pay attention to whether the BMC has completed receiving the update start information. Instead, the target firmware is switched from the running state to the paused running state, and the operating system is switched from the paused running state to the running state. The target firmware is then updated from the first version to the second version by the target program. It may be understood that when the update start information is sent to the BMC, the target firmware is updated by the target program, reducing the time waiting for the BMC to complete receiving the update start information and improving the efficiency of firmware updates.

In the technical solution provided in step S304 above, the second version information is the description information of the second version, which may include but is not limited to the version number, version size, and version source of the second version. For example, the version number of the second version is V3.0, the version size is 40M, and the version source is the software 2.

In this embodiment, BMC may record the received update end information in the target log, but is not limited to it. For example, when the firmware of the server is completely updated by the target program in the operating system of the server, the BMC records in the log as: b month cth, a year at 16:00, the firmware version number is V3.0 and the update is completed.

In an exemplary embodiment, it may be performed, but is not limited to, through the following method to acquire second version information of the target firmware, and send update end information to the BMC in response to the target firmware being completely updated from the first version to the second version by the target program: executing a second function that is preset in response to the target firmware being completely updated from the first version to the second version by the target program, wherein the second function is used for acquiring the second version information of the target firmware, and sending the update end information to the BMC.

In this embodiment, the second function that is preset may be, but is not limited to, a function of target type. As an example, the function of target type may include, but is not limited to, a function of SMM module type.

In this embodiment, the second function may be used, but is not limited to, to obtain the second version information of the target firmware and send the update end information to the BMC, enabling the BMC to receive the second version information of the target firmware after the update in a timely manner when the target firmware in the server is completely updated from the first version to the second version by the target program in the operating system of the server.

In an exemplary embodiment, it may be performed, but is not limited to, through the following method to execute the second function that is preset in response to the target firmware being completely updated from the first version to the second version by the target program: executing, by the target firmware, the second function in response to the target firmware being completely updated from the first version to the second version by the target program, to acquire the second version information of the target firmware, and send the update end information to the BMC.

In this embodiment, when the target firmware in the server is completely updated from the first version to the second version by the target program, the second function may be executed by the target firmware, but is not limited to this, to acquire the second version information of the target firmware, and send the update end information to the BMC.

In an exemplary embodiment, it may be performed, but is not limited to, through the following method to execute, by the target firmware, the second function in response to the target firmware being completely updated from the first version to the second version by the target program: in response to the target firmware being completely updated from the first version to the second version by the target program, switching the operating system from a running state to a paused running state, switching the target firmware from the paused running state to the running state, and executing the second function by the target firmware.

In this embodiment, when the target firmware in the server is completely updated from the first version to the second version by the target program, it may switch the operating system of the server from the running state to the paused running state, but is not limited to it, for example, the operating system of the server is switched from running to paused running, the target firmware may be switched from the paused running state to the running state, for example, the target firmware is switched from paused running to running, and the second function is executed by the target firmware.

In an exemplary embodiment, it may be performed, but is not limited to, through the following method to execute, by the target firmware, the second function in response to the target firmware being completely updated from the first version to the second version by the target program: in response to the target firmware being completely updated from the first version to the second version by the target program, triggering a target interruption, and executing the second function by the target firmware, wherein the second function is a function that is triggered to execute after the target interruption is triggered.

In this embodiment, the target interrupt may be used, but is not limited to, to transfer the control power from the operating system of the server to the target firmware. It may be understood that the target interrupt may be used to switch the operating system of the server from the running state to the paused running state, and to switch the target firmware from the paused running state to the running state, but is not limited to this. The target interrupt may include but is not limited to the SMI interrupt.

For example, when the target firmware in the server is completely updated from the first version to the second version by the target program (such as update from version 1.02 to version 1.03 is completed), it may trigger the SMI interrupt to enter the SMM mode, but is not limited to it. And at this point, the control power will be transferred from the OS to the target firmware. The target firmware executes the second SMM module function (also known as the second function).

In an exemplary embodiment, it may be performed, but is not limited to, through the following method to execute, by the target firmware, the second function: in response to the first version of the target firmware being copied from a first storage space to a second storage space, executing the second function by the first version of the target firmware stored in the second storage space, wherein the second storage space is a storage space in a memory of the server, the second function is used for reading the second version information from the first storage space and sending the update end information to the BMC, the first storage space is used for storing the second function, a current version of the target firmware and current version information of the target firmware; and when the current version of the target firmware is the second version, the current version information is the second version information.

In this embodiment, in order to improve the efficiency, it may include, but is not limited to, copying the first version of the target firmware stored in the first storage space to the second storage space. The second function is executed by the first version of the target firmware stored in the second storage space.

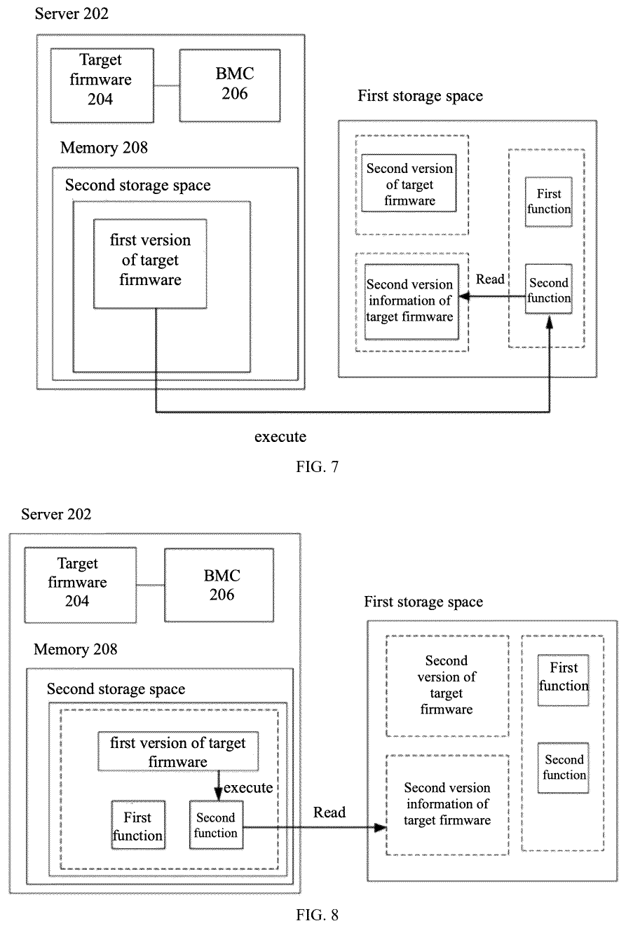

FIG. 7 is a first schematic diagram of an example for executing the second function according to an embodiment of the present application. As shown in FIG. 7, the target firmware 204, the BMC (Baseboard Management Controller) 206, and the memory 208 are deployed on the server 202, and the second storage space is deployed in the memory 208. The first storage space is used to store the first function, the second function, the current version of the target firmware, and the current version information of the target firmware. When the current version of the target firmware is the second version, the current version information is the second version information. It may be understood that the target firmware in the server is completely updated from the first version to the second version by the target program.

It may execute the second function by the first version of the target firmware stored in the second storage space when the first version of the target firmware is copied from the first storage space to the second storage space, but is not limited to it. For example, its operation is to obtain the second version information of the target firmware stored at positions from 0x20FF0 to 0x20FFF in the first storage space through the way of read-write IO interface.

In an exemplary embodiment, it may be performed, but is not limited to, through the following method to execute the second function that is preset: executing a third part of a code of the second function, wherein the third part of the code of the second function is used for reading the second version information from the first storage space, the first storage space is used for storing a current version of the target firmware and current version information of the target firmware; when the current version of the target firmware is the second version, the current version information is the second version information; and executing a fourth part of the code of the second function, wherein the fourth part of the code of the second function is used for sending the update end information to the BMC.

In this embodiment, the second function may include, but is not limited to, the third part of the code and the fourth part of the code. The third part of the code may be used, but is not limited to, to read the second version information from the first storage space, such as the version number, version size, and version source of the second version. The fourth part of the code can, but is not limited to, send the update end information carrying the second version information to the BMC.

In an exemplary embodiment, it may be performed, but is not limited to, through the following method to execute the second function that is preset: executing the second function stored in a first storage space, wherein the second function is used for reading the second version information from the first storage space and sending the update end information to the BMC, the first storage space is used for storing the second function, a current version of the target firmware and current version information of the target firmware; and when the current version of the target firmware is the second version, the current version information is the second version information; or in response to the second function being copied from the first storage space to a second storage space, executing the second function stored in the second storage space, wherein the second storage space is a storage space in a memory of the server, the second function is used for reading the second version information from the first storage space and sending the update end information to the BMC, the first storage space is used for storing the second function, the current version of the target firmware and the current version information of the target firmware; and when the current version of the target firmware is the second version, the current version information is the second version information.

In this embodiment, the second function stored in the second storage space can be executed by the first version of the target firmware in the second storage space, but is not limited to it, as shown in FIG. 7. Only the first version of the target firmware is copied to the second storage space, and then the second function stored in the first storage space is executed by the first version of the target firmware in the second storage space. In this way, the storage space of the memory occupied by the second function is reduced, and the utilization of the storage space of the memory is improved.

In this embodiment, FIG. 8 is a second schematic diagram of an example for executing the second function according to the embodiment of the present application. As shown in FIG. 8, the target firmware 204, the BMC (Baseboard Management Controller) 206, and the memory 208 are deployed on the server 202, and a second storage space is deployed in the memory 208. The first storage space is used for storing the first function, the second function, the current version of the target firmware, and the current version information of the target firmware. When the current version of the target firmware is the second version, the current version information is the second version information.

When the first version of the target firmware and the second function are copied from the first storage space to the second storage space, the second function stored in the second storage space can be executed by the first version of the target firmware in the second storage space but is not limited to it. In this way, the time required for the first version of the target firmware in the second storage space to execute the second function stored in the first storage space is saved, and the efficiency of executing functions in the memory is improved.

In an exemplary embodiment, it may be performed, but is not limited to, through the following method to update the current version information stored in the first storage space: in response to the target firmware being completely updated from the first version to the second version by the target program, updating the current version information stored in the first storage space from the first version information to the second version information, wherein when the current version of the target firmware is the second version, the current version information is the second version information.

In this embodiment, when the target firmware is completely updated from the first version to the second version by the target program, the current version information stored in the first storage space may be updated from the first version information to the second version information, but is not limited to it. For example, the first version information of the target firmware stored at positions 0x20FF0 to 0x20FFF in the first storage space is updated to the second version information.

In an exemplary embodiment, it may be performed, but is not limited to, through the following method to send the update end information to the BMC: invoking a target interface to send the update end information to the BMC.

In this embodiment, the target interface is an interface between the BMC and the target firmware. As an example, the target interface is an interface that meets the target protocol. Optionally, the target interface may include but is not limited to an interface that meets the IPMI protocol.

In an exemplary embodiment, it may be performed, but is not limited to, through the following method to send the update end information to the BMC: sending the update end information to the BMC, wherein the update end information further includes second state information, and the second state information is used for indicating completion of updating the target firmware.

In this embodiment, the second state information may be fixed in the second function, but is not limited to it. It may be understood that in response to triggering the execution of the second function after triggering the target interrupt, it may indicate the completion of updating the target In this embodiment, the update end information may also include but is not limited to third state information, where the third state information is used to indicate the upgrade status of the target firmware after completing the update of the target firmware, for example, which is whether the version of the target firmware is upgraded or downgraded, or refreshing the same version of the target firmware.

In an exemplary embodiment, the target firmware includes at least one of the following: a basic input output system (BIOS), a complex programmable logic device (CPLD), a field replaceable unit (FRU), and a power management device.

In this embodiment, the target firmware may include but is not limited to at least one of the following: the basic input output system (BIOS), the complex programmable logic device (CPLD), the field replaceable unit (FRU), the power management device, and a network card.

In this embodiment, the network card may include but is not limited to hot swappable network card devices, such as, ocp (open compute project network interface) network card, or other network cards, the present application does not limit this. In this way, by transferring the control power from the system to the BIOS through the target interrupts, information transmission including but not limited to BIOS version numbers may be achieved, and some monitoring functions that the BMC is unable to actively complete may also be realized, expanding the monitoring scope of the BMC.

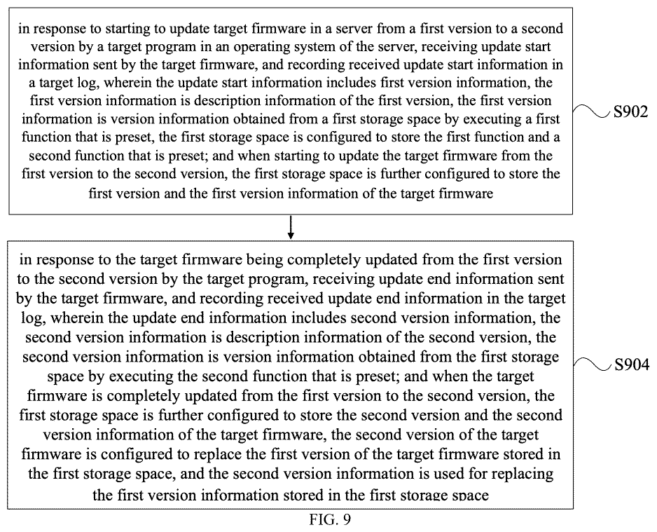

In this embodiment, another method for generating a server log is also provided. FIG. 9 is a second flow chart of the method for generating the server log according to the embodiment of the present application, as shown in FIG. 9, which includes the following steps:
Step S902: in response to starting to update target firmware in a server from a first version to a second version by a target program in an operating system of the server, receiving update start information sent by the target firmware, and recording received update start information in a target log, wherein the update start information includes first version information, the first version information is description information of the first version, the first version information is version information obtained from a first storage space by executing a first function that is preset, the first storage space is configured to store the first function and a second function that is preset; and when starting to update the target firmware from the first version to the second version, the first storage space is further configured to store the first version and the first version information of the target firmware; and
Step S904: in response to the target firmware being completely updated from the first version to the second version by the target program, receiving update end information sent by the target firmware, and recording received update end information in the target log, wherein the update end information includes second version information, the second version information is description information of the second version, the second version information is version information obtained from the first storage space by executing the second function that is preset; and when the target firmware is completely updated from the first version to the second version, the first storage space is further configured to store the second version and the second version information of the target firmware, the second version of the target firmware is configured to replace the first version of the target firmware stored in the first storage space, and the second version information is used for replacing the first version information stored in the first storage space.

Through the above steps, when starting to update the firmware in the server by tools in the operating system of the server, it may obtain the first version information of the firmware before the update, and the BMC receives the update start information carrying the first version information sent by the target firmware, but is not limited to it. And when the firmware in the server is completely updated by the tools in the operating system of the server, the BMC receives the update end information carrying the second version information sent by the target firmware. In this way, it is achieved to send the update start information and update end information to the BMC when updating the firmware in the server by the tools in the operating system of the server, the BMC records the update start information and update end information in the log. Therefore, it may solve the problem of the BMC being unable to record the version information of the firmware in the log when updating the firmware in the server by the target program in the operating system of the server. This achieves the technical effect of the BMC being able to record the version information of the firmware in the log when updating the firmware in the server by the target program in the operating system of the server.

Among them, the executing entity of the above steps may be a server or the like, but is not limited to this.

In the technical solution provided in step S902 above, when starting to update the target firmware in the server from the first version to the second version by the target program in the operating system of the server, the target firmware can, but is not limited to, send the update start information to the BMC. The BMC receives the update start information sent by the target firmware and records the received update start information in the target log.

In this embodiment, when the target firmware in the server is completely updated from the first version to the second version by the target program in the operating system of the server, the target firmware may, but is not limited to, send the update end information to the BMC. The BMC receives the update end information sent by the target firmware and records the received update end information in the target log.

In an exemplary embodiment, the update start information further includes first state information, the first state information is used for indicating start of updating the target firmware; the update end information further includes second state information, and the second state information is used for indicating completion of updating the target firmware.

In this embodiment, the update end information may also include but is not limited to third state information, where the third state information is used to indicate the upgrade status of the target firmware after completing the update of the target firmware, for example, which is whether the version of the target firmware is upgraded or downgraded, or refreshing the same version of the target firmware.

For example, when the target firmware is completely updated from the first version to the second version by the target program, and the second version is higher than the first version, the third state information may, but is not limited to, upgrade the version of the target firmware. When the target firmware is completely updated from the first version to the second version by the target program, and the second version is lower than the first version, the third state information may, but is not limited to, downgrade the version of the target firmware. When the target firmware is completely updated from the first version to the second version through the target program, and the second version is the same as the first version, the third state information may, but is not limited to, refresh the version of the target firmware.

For example, when the target firmware is completely updated from the first version to the second version by the target program, and the second version is higher than the first version, the third state information may be, but is not limited to, upgrade the version of the target firmware. In such a case, the BMC can, but is not limited to, record the completion time of the update, the second version information of the target firmware, the completion of the update, and the upgrade of the version of the target firmware in the target log. As an example, it may, but is not limited to, record “b month cth, a year at 17:00, the version of the target firmware is V4.2, the update is completed, and the version of the target firmware is upgraded”in the target log.

Through the embodiments of the present application, taking the target firmware as BIOS as an example, when the server updates the BIOS version in the system, it triggers the target interrupt and utilizes the feature of changing the content of the Flash device after updating the BIOS to record the change record of the BIOS version numbers by the BIOS. The current BIOS version number is recorded by specifying the address content through the BIOS, and the corresponding BIOS version number is obtained. Implementing SEL recording through the BIOS code covers situations of updating the BIOS firmware that the BMC cannot monitor. Therefore, it may solve the problem of the BMC being unable to record the BIOS version change records SEL when updating the BIOS under the system.

In order to better understand the method for generating the server log in the embodiments of the present application, the target firmware being the BIOS may be taken as an example to explain and illustrate the method for generating the server log in the embodiments of the present application, which may be applied to the embodiments of the present application.

During the BIOS code development phase, the server needs to allocate a space with a designated position in advance to the BIOS area for storing the version information, such as the BIOS version number. For example, it is defined to allocate the space from 0x20FF0 to 0x20FFF to store the current BIOS version number and other information. Two functions of SMM module type are added to obtain the current BIOS version number, and the current update state and BIOS version number are transferred to the BMC through the agreed IPMI command. The first SMM module function (or known as the first function) is triggered before the update tool of the system updates the BIOS firmware, it is set to record the status of updating the BIOS firmware (such as starting to update the BIOS, equivalent to the first state information) and the BIOS version information, which are transferred to the BMC for parsing through the IPMI commands. The second SMM module function (or known as the second function) is triggered when the update tool of the system completes updating the BIOS firmware, it is set to record the update state of the BIOS (e.g. the update of the BIOS is completed, equivalent to the second state information) and the version information after updating the BIOS, which are transferred to the BMC for parsing through the IPMI commands.

When the server starts to update the BIOS firmware in the system (such as updating the BIOS from the version 1.02 to the version 1.03), it triggers an SMI interrupt to enter the SMM mode. At this time, the control power is transferred from the OS to the BIOS, and the BIOS executes the first SMM module function (equivalent to the first function). Its operation is to obtain the information stored at positions 0x20FF0 to 0x20FFF through the way of read-write IO interface (the old version information is 1.02), and the information is sent to the BMC through the IPMI commands. The BMC parses the information transferred by the BIOS (starts to update the BIOS firmware, the current version number is 1.02). Then the BIOS exits the SMM mode, and the system continues to perform the operation of updating the BIOS. After updating the BIOS firmware, the BIOS flash contains the contents of the BIOS with a new version, and the information stored at the positions 0x20FF0 to 0x20FFF has been changed to 1.03. The target interrupt (e.g. SMI interrupt) is triggered, the control power is transferred from the system to the BIOS, and the BIOS executes the second SMM module function (equivalent to the second function), which is used to obtain the information stored at the positions 0x20FF0 to 0x20FFF through the way of read-write IO interface (1.03), and the information is sent to the BMC through the IPMI commands. The BMC parses the information transferred by the BIOS (the update of the BIOS is completed, and the current version number is 1.03).

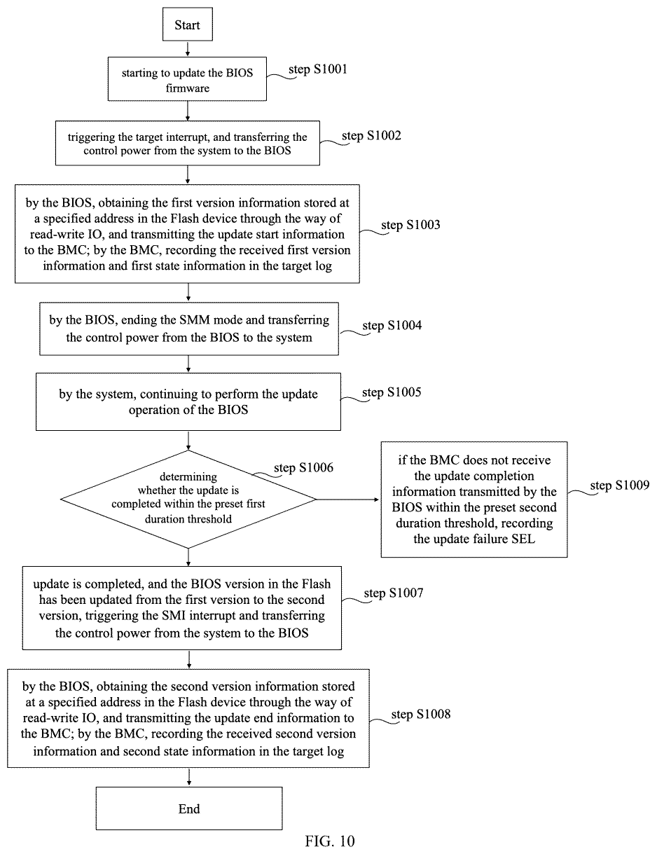

FIG. 10 is a schematic diagram of a method for generating a server log according to an embodiment of the present application, as shown in FIG. 10, it may be, but is not limited to, using the target firmware being the BIOS as an example, and may include the following steps:
Step S1001, starting to update the BIOS firmware, for example, performing an update operation of the BIOS firmware under the operating system of the server.
Step S1002, triggering the target interrupt (e.g. SMI interrupt), and transferring the control power from the system to the BIOS.
Step S1003, by the BIOS, obtaining the first version information stored at a specified address in the Flash device through the way of read-write IO, and transmitting the update start information to the BMC. The update start information includes the first version information and the first state information (e.g., starting to update the BIOS). The BMC records the received first version information and first state information in the target log (e.g. SEL). For example, the BIOS obtains the version information stored at the position offset 0x20FF0 in the BIOS Flash through the way of read-write IO (e.g. the current version number being 1.02). The BIOS sends the update state (such as starting to update the BIOS firmware) and the version information of the current BIOS, such as the version number of the current BIOS (1.02), to the BMC through the target interface (such as the IPMI interface). The BMC parses this IPMI command and presents it to the system time log (SEL, equivalent to the target log).
Step S1004, by the BIOS, ending the SMM mode and transferring the control power from the BIOS to the system.
Step S1005, by the system, continuing to perform the update operation of the BIOS firmware, which usually takes 3 to 5 minutes.
Step S1006, determining whether the update is completed within the preset first duration threshold (e.g. 10 minutes or 20 minutes, etc.); if the update is completed within the preset first duration threshold, executing steps S1007 to S1008; if the update is not completed within the preset duration threshold, executing step S1009.
Step S1007, update completed. The BIOS version in the Flash has been updated from the first version to the second version, triggering the SMI interrupt and transferring the control power from the system to the BIOS. For example, when the update of the BIOS firmware is completed, the version information stored on 0x20FF0 to 0x20FFF in the Flash (equivalent to the first storage space) is updated from the first version to the second version, for example, from the version number 1.02 to the version number 1.03, triggering the target interrupt (such as SMI interrupt) and transferring the control power from the system to the BIOS.
Step S1008, by the BIOS, obtaining the second version information stored at a specified address in the Flash device through the way of read-write IO, and transmitting the update end information to the BMC. The update end information includes the second version information and the first state information (e.g., starting to update the BIOS). The BMC records the received second version information and second state information in the target log (e.g. SEL). For example, the BIOS obtains the information stored at the position offset 0x20FF0 to 0x20FFF in the BIOS Flash through the way of read-write IO (e.g., the current version: 1.03). The BIOS sends the update state (update completed) and the version number (1.03) to the BMC through the IPMI interface. The BMC parses the IPMI command and presents it to the system time log (SEL, equivalent to the target log).
Step S1009, if the BMC does not receive the update completion information transmitted by the BIOS within the preset second duration threshold, recording the update failure SEL. If the update is not completed within the preset second duration threshold, the BMC starts timing from step S1003. If the BMC does not obtain the update end information transmitted by the BIOS within the preset second duration threshold (such as 10 minutes or 15 minutes, etc., which is not limited in the present application), reporting the update failure SEL of the BIOS firmware.

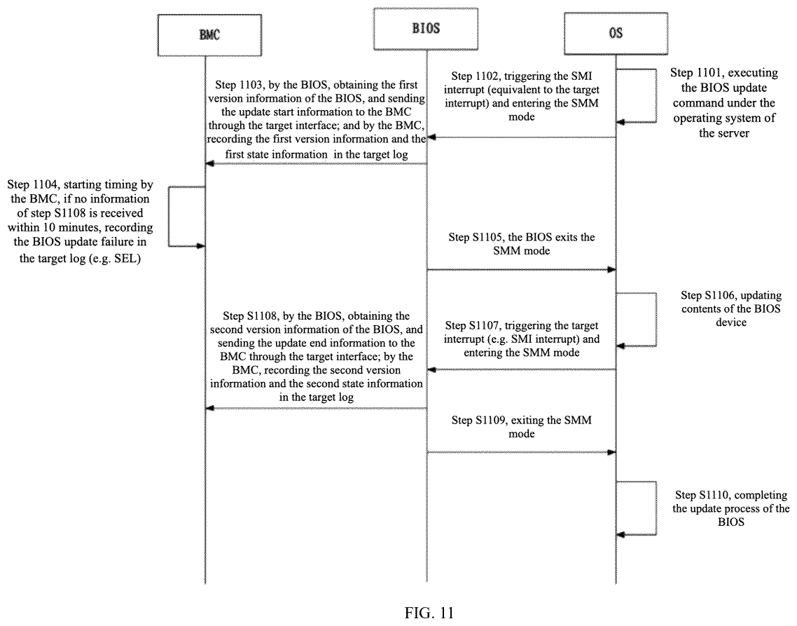

FIG. 11 is a timing diagram of an example of the method for generating the server log according to an embodiment of the present application. As shown in FIG. 11, the target firmware being the BIOS may be taken as an example, but is not limited to it, and it may include the following steps.
Step 1101, executing the BIOS update command under the operating system of the server (equivalent to starting to update the BIOS from the first version to the second version by the target program in the operating system of the server).
Step 1102, triggering the SMI interrupt (equivalent to the target interrupt) and entering the SMM mode.
Step 1103, by the BIOS, obtaining the first version information of the BIOS, such as the old version number of the BIOS, and sending the update start information to the BMC through the target interface (such as the IPMI interface); and by the BMC, recording the update start information in the target log (such as SEL). The update start information includes the first version information and the first state information. The first state information is used for indicating the start of updating the BIOS.
Step 1104, starting timing by the BMC, if no information of step S1108 is received within 10 minutes (or 15 minutes, 20 minutes, etc., which is not limited in the present application), recording the BIOS update failure in the target log (e.g. SEL).
Step S1105, the BIOS exits the SMM mode.
Step S1106, updating contents of the BIOS device, for example, updating the BIOS from the first version to the second version.
Step S1107, triggering the target interrupt (e.g. SMI interrupt) and entering the SMM mode.
Step S1108, by the BIOS, obtaining the second version information of the BIOS, such as the new version number after updating the BIOS, and sending the update end information to the version information and the second state information in the target log (such as SEL), where the update end information includes the second version information and the second state information, and the second state information is used to indicate the completion of updating the BIOS.
Step S1109, exiting the SMM mode.
Step S1110, completing the update process of the BIOS version.

Through the above embodiment, the SMI interrupt is triggered under the operating system of the server, and the feature of changing the content of Flash devices after updating the BIOS firmware is utilized. The current actual version number is obtained by the BIOS, and related information is transmitted to the BMC through the IPMI command by the BIOS. This achieves the generation of change records of the BIOS version number during BIOS firmware updates in the system, making up for the shortcomings of the current solution that may only record the change records of the BIOS version number in the BIOS update scenarios by the BMC, and realizing timely acquisition of the BIOS version numbers.

Through the description of the above embodiments, those skilled in the art may clearly understand that the method according to the above embodiments may be implemented through the software and necessary general hardware platforms, or through the hardware, but in many cases, the former is a better implementation. Based on this understanding, the technical solution of the present application may essentially or contribute to the prior art in the form of a software product, which is stored in a non-transitory readable storage medium (such as ROM/RAM, magnetic disk, optical disk) and includes several instructions to enable a terminal device (which may be a mobile phone, computer, server, or network device, etc.) to execute the methods of various embodiments of the present application.

In this embodiment, an apparatus for generating a server log is also provided, which is set to implement the above embodiments, and those that have already been described will not be repeated. As used below, the term “module” may refer to a combination of software and/or hardware that may implement predetermined functions. Although the devices described in the following embodiments are implemented in the software, the hardware or the combination of the software and the hardware implementation is also possible and envisioned.

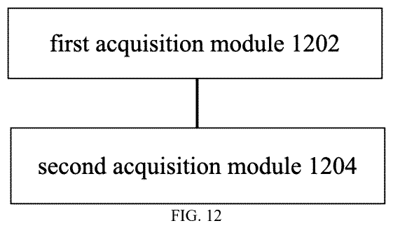

FIG. 12 is a structural block diagram of an apparatus for generating a server log according to an embodiment of the present application, as shown in FIG. 12, the apparatus includes:
a first acquisition module 1202 configured for, in response to starting to update target firmware in a server from a first version to a second version by a target program in an operating system of the server, acquiring first version information of the target firmware, and sending update start information to a baseboard management controller (BMC) of the server, wherein the update start information includes the first version information, the first version information is description information of the first version, and the BMC is configured to record received update start information in a target log; and
a second acquisition module 1204 configured for, in response to the target firmware being completely updated from the first version to the second version by the target program, acquiring second version information of the target firmware, and sending update end information to the BMC, wherein the update end information includes the second version information, the second version information is description information of the second version, and the BMC is configured to record received update end information in the target log.

In an exemplary embodiment, the first acquisition module includes:
a first execution unit configured for, executing a first function that is preset in response to starting to update the target firmware in the server from the first version to the second version by the target program, wherein the first function is used for acquiring the first version information of the target firmware, and sending the update start information to the BMC.

In an exemplary embodiment, the first execution unit is configured for:
executing, by the target firmware, the first function in response to starting to update the target firmware in the server from the first version to the second version by the target program, to acquire the first version information of the target firmware, and send the update start information to the BMC.

In an exemplary embodiment, the first execution unit is configured for:
in response to starting to update the target firmware in the server from the first version to the second version by the target program, switching the operating system from a running state to a paused running state, switching the target firmware from the paused running state to the running state, and executing the first function by the target firmware.

In an exemplary embodiment, the first execution unit is configured for:
in response to starting to update the target firmware in the server from the first version to the second version by the target program, triggering a target interruption, and executing the first function by the target firmware, wherein the first function is a function that is triggered to execute after the target interruption is triggered.

In an exemplary embodiment, the first execution unit is configured for:
in response to the first version of the target firmware being copied from a first storage space to a second storage space, executing the first function by the first version of the target firmware stored in the second storage space, wherein the second storage space is a storage space in a memory of the server, the first function is used for reading the first version information from the first storage space and sending the update start information to the BMC, the first storage space is used for storing the first function, a current version of the target firmware and current version information of the target firmware; and when the current version of the target firmware is the first version, the current version information is the first version information.

In an exemplary embodiment, the first execution unit is configured for:
executing a first part of a code of the first function, wherein the first part of the code is used for reading the first version information from the first storage space, the first storage space is used for storing a current version of the target firmware and current version information of the target firmware; when the current version of the target firmware is the first version, the current version information is the first version information; and
executing a second part of the code of the first function, wherein the second part of the code is used for sending the update start information to the BMC.

In an exemplary embodiment, the apparatus further includes:
a storage module configured for, before executing the first function that is preset, in response to the first version information being version information of an initial version of the target firmware, storing the first version information in the first storage space; or a first update module configured for, in response to the target firmware being completely updated from a third version to the first version by the target program, updating the current version information stored in the first storage space from third version information to the first version information, wherein the third version information is description information of the third version.

In an exemplary embodiment, the first execution unit is configured for:
executing the first function stored in a first storage space, wherein the first function is used for reading the first version information from the first storage space and sending the update start information to the BMC, the first storage space is used for storing the first function, a current version of the target firmware and current version information of the target firmware; and when the current version of the target firmware is the first version, the current version information is the first version information; or in response to the first function being copied from the first storage space to a second storage space, executing the first function stored in the second storage space, wherein the second storage space is a storage space in a memory of the server, the first function is used for reading the first version information from the first storage space and sending the update start information to the BMC, the first storage space is used for storing the first function, the current version of the target firmware and the current version information of the target firmware; and when the current version of the target firmware is the first version, the current version information is the first version information.

In an exemplary embodiment, the first acquisition module includes: a first sending unit, configured for invoking a target interface to send the update start information to the BMC.

In an exemplary embodiment, the first acquisition module includes: a second sending unit, configured for sending the update start information to the BMC, wherein the update start information further includes first state information, and the first state information is used for indicating start of updating the target firmware.

In an exemplary embodiment, the apparatus further includes: a switching module configured for, before the step of, in response to the target firmware being completely updated from the first version to the second version by the target program, acquiring the second version information of the target firmware, and sending the update end information to the BMC, and after sending the update start information to the BMC, switching the target firmware from the running state to the paused running state, switching the operating system from the paused running state to the running state, continuing to update the target firmware from the first version to the second version by the target program.

In an exemplary embodiment, the second acquisition module includes:
a second execution unit, configured for executing a second function that is preset in response to the target firmware being completely updated from the first version to the second version by the target program, wherein the second function is used for acquiring the second version information of the target firmware, and sending the update end information to the BMC.

In an exemplary embodiment, the second execution unit is configured for:
executing, by the target firmware, the second function in response to the target firmware being completely updated from the first version to the second version by the target program, to acquire the second version information of the target firmware, and send the update end information to the BMC.

In an exemplary embodiment, the second execution unit is configured for:
in response to the target firmware being completely updated from the first version to the second version by the target program, switching the operating system from a running state to a paused running state, switching the target firmware from the paused running state to the running state, and executing the second function by the target firmware.

In an exemplary embodiment, the second execution unit is configured for:
in response to the target firmware being completely updated from the first version to the second version by the target program, triggering a target interruption, and executing the second function by the target firmware, wherein the second function is a function that is triggered to execute after the target interruption is triggered.

In an exemplary embodiment, the second execution unit is configured for:
in response to the first version of the target firmware being copied from a first storage space to a second storage space, executing the second function by the first version of the target firmware stored in the second storage space, wherein the second storage space is a storage space in a memory of the server, the second function is used for reading the second version information from used for storing the second function, a current version of the target firmware and current version information of the target firmware; and when the current version of the target firmware is the second version, the current version information is the second version information.

In an exemplary embodiment, the second execution unit is configured for:
executing a third part of a code of the second function, wherein the third part of the code of the second function is used for reading the second version information from the first storage space, the first storage space is used for storing a current version of the target firmware and current version information of the target firmware; when the current version of the target firmware is the second version, the current version information is the second version information; and
executing a fourth part of the code of the second function, wherein the fourth part of the code of the second function is used for sending the update end information to the BMC.

In an exemplary embodiment, the second execution unit is configured for:
executing the second function stored in a first storage space, wherein the second function is used for reading the second version information from the first storage space and sending the update end information to the BMC, the first storage space is used for storing the second function, a current version of the target firmware and current version information of the target firmware; and when the current version of the target firmware is the second version, the current version information is the second version information; or in response to the second function being copied from the first storage space to a second storage space, executing the second function stored in the second storage space, wherein the second storage space is a storage space in a memory of the server, the second function is used for reading the second version information from the first storage space and sending the update end information to the BMC, the first storage space is used for storing the second function, the current version of the target firmware and the current version information of the target firmware; and when the current version of the target firmware is the second version, the current version information is the second version information.

In an exemplary embodiment, the apparatus further includes a second update module configured for, in response to the target firmware being completely updated from the first version to the second version by the target program, updating the current version information stored in the first storage space from the first version information to the second version information, wherein when the current version of the target firmware is the second version, the current version information is the second version information.

In an exemplary embodiment, sending the update end information to the BMC, includes: invoking a target interface to send the update end information to the BMC.

In an exemplary embodiment, the second acquisition module includes: a third sending unit, configured for sending the update end information to the BMC, wherein the update end information further includes second state information, and the second state information is used for indicating completion of updating the target firmware.

In an exemplary embodiment, the target firmware includes at least one of the following:
a basic input output system (BIOS), a complex programmable logic device (CPLD), a field replaceable unit (FRU), and a power management device.

In this embodiment, another apparatus for generating the server log is also provided, including:
a first receiving module configured for, in response to starting to update target firmware in a server from a first version to a second version by a target program in an operating system of the server, receiving update start information sent by the target firmware, and recording received update start information in a target log, wherein the update start information includes first version information, the first version information is description information of the first version, the first version information is version information obtained from a first storage space by executing a first function that is preset, the first storage space is configured to store the first function and a second function that is preset; and when starting to update the target firmware from the first version to the second version, the first storage space is further configured to store the first version and the first version information of the target firmware; and
a second receiving module configured for, in response to the target firmware being completely updated from the first version to the second version by the target program, receiving update end information sent by the target firmware, and recording received update end information in the target log, wherein the update end information includes second version information, the second version information is description information of the second version, the second version information is version information obtained from the first storage space by executing the second function that is preset; and when the target firmware is completely updated from the first version to the second version, the first storage space is further configured to store the second version and the second version information of the target firmware, the second version of the target firmware is configured to replace the first version of the target firmware stored in the first storage space, and the second version information is used for replacing the first version information stored in the first storage space.

In an exemplary embodiment, the update start information further includes first state information, the first state information is used for indicating start of updating the target firmware; the update end information further includes second state information, and the second state information is used for indicating completion of updating the target firmware.

It should be noted that the above modules may be implemented through software or hardware. For the latter, they may be implemented through the following methods, but not limited to: the above modules are all located in the same processor; alternatively, the above modules may be located in different processors in any combination.

The embodiments of the present application also provide a non-transitory computer-readable storage medium, which stores a computer program, among them, the computer program is configured to execute the steps of any one of the method embodiments described above during running.

In an exemplary embodiment, the aforementioned non-transitory computer-readable storage medium may include, but are not limited to, various media that may store computer programs, such as USB flash drives, Read-Only Memory (ROM), Random Access Memory (RAM), portable hard drives, magnetic disks, or optical disks.

The embodiments of the present application also provide an electronic device including a memory and a processor, wherein the memory stores a computer program, and the processor is configured to run the computer program to perform the steps of any one of the method embodiments described above.

In an exemplary embodiment, the electronic device may further include a transmission device and an input-output device, among them, the transmission device is connected to the processor, and the input-output device is connected to the processor.

The examples in this embodiment may refer to the examples described in the above embodiments and exemplary embodiments, and this embodiment will not be repeated here.

Obviously, those skilled in the art should understand that the modules or steps of the present application described above may be implemented using general-purpose computing devices, which may be centralized on a single computing device or distributed on a network composed of multiple computing devices. They may be implemented using program code executable by the computing device, and may be stored in a storage device for execution by the computing device. In some cases, the steps shown or described may be executed in a different order than here, or they may be separately made into various integrated circuit modules, or multiple modules or steps in them may be made into a single integrated circuit module for implementation. Thus, the present application is not limited to any specific combination of hardware and software.

The above are only some embodiments of the present application and are not intended to limit the present application. For those skilled in the art, the present application may have various modifications and variations. Any modifications, equivalent substitutions, improvements, etc. made within the principles of the present application shall be included within the scope of protection of the present application.

1. A method for generating a server log, comprising:
in response to starting to update target firmware in a server from a first version to a second version by a target program in an operating system of the server, acquiring first version information of the target firmware, and sending update start information to a baseboard management controller (BMC) of the server, wherein the update start information comprises the first version information, the first version information is description information of the first version, and the BMC is configured to record received update start information in a target log; and
in response to the target firmware being completely updated from the first version to the second version by the target program, acquiring second version information of the target firmware, and sending update end information to the BMC, wherein the update end information comprises the second version information, the second version information is description information of the second version, and the BMC is configured to record received update end information in the target log;
wherein in response to starting to update target firmware in a server from a first version to a second version by a target program in an operating system of the server, acquiring first version information of the target firmware, and sending update start information to a baseboard management controller (BMC) of the server, comprises:
executing a first function that is preset in response to starting to update the target firmware in the server from the first version to the second version by the target program, wherein the first function is used for acquiring the first version information of the target firmware, and sending the update start information to the BMC.

2. (canceled)

3. The method according to claim 21, wherein
the executing the first function that is preset in response to starting to update the target firmware in the server from the first version to the second version by the target program comprises:
executing, by the target firmware, the first function in response to starting to update the target firmware in the server from the first version to the second version by the target program, to acquire the first version information of the target firmware, and send the update start information to the BMC.

4. The method according to claim 3, wherein
the executing, by the target firmware, the first function in response to starting to update the target firmware in the server from the first version to the second version by the target program comprises:
in response to starting to update the target firmware in the server from the first version to the second version by the target program, switching the operating system from a running state to a paused running state, switching the target firmware from the paused running state to the running state, and executing the first function by the target firmware.

5. The method according to claim 3, wherein
the executing, by the target firmware, the first function in response to starting to update the target firmware in the server from the first version to the second version by the target program comprises:
in response to starting to update the target firmware in the server from the first version to the second version by the target program, triggering a target interruption, and executing the first function by the target firmware, wherein the first function is a function that is triggered to execute after the target interruption is triggered.

6. The method according to claim 3, wherein
the executing, by the target firmware, the first function comprises:
in response to the first version of the target firmware being copied from a first storage space to a second storage space, executing the first function by the first version of the target firmware stored in the second storage space, wherein the second storage space is a storage space in a memory of the server, the first function is used for reading the first version information from the first storage space and sending the update start information to the BMC, the first storage space is used for storing the first function, a current version of the target firmware and current version information of the target firmware; and when the current version of the target firmware is the first version, the current version information is the first version information.

7. The method according to claim 21, wherein
the executing the first function that is preset comprises:
executing a first part of a code of the first function, wherein the first part of the code is used for reading the first version information from the first storage space, the first storage space is used for storing a current version of the target firmware and current version information of the target firmware; when the current version of the target firmware is the first version, the current version information is the first version information; and
executing a second part of the code of the first function, wherein the second part of the code is used for sending the update start information to the BMC.

8. The method according to claim 7, wherein
before executing the first function that is preset, the method further comprises:
in response to the first version information being version information of an initial version of the target firmware, storing the first version information in the first storage space; or
in response to the target firmware being completely updated from a third version to the first version by the target program, updating the current version information stored in the first storage space from third version information to the first version information, wherein the third version information is description information of the third version.

9. The method according to claim 21, wherein
the executing the first function that is preset comprises:
executing the first function stored in a first storage space, wherein the first function is used for reading the first version information from the first storage space and sending the update start information to the BMC, the first storage space is used for storing the first function, a current version of the target firmware and current version information of the target firmware; and when the current version of the target firmware is the first version, the current version information is the first version information; or
in response to the first function being copied from the first storage space to a second storage space, executing the first function stored in the second storage space, wherein the second storage space is a storage space in a memory of the server, the first function is used for reading the first version information from the first storage space and sending the update start information to the BMC, the first storage space is used for storing the first function, the current version of the target firmware and the current version information of the target firmware; and
when the current version of the target firmware is the first version, the current version information is the first version information.

10. The method according to claim 1, wherein
the sending the update start information to the baseboard management controller (BMC) of the server comprises: invoking a target interface to send the update start information to the BMC.

11. The method according to claim 1, wherein
the sending the update start information to the baseboard management controller (BMC) of the server comprises: sending the update start information to the BMC, wherein the update start information further comprises first state information, and the first state information is used for indicating start of updating the target firmware.

12. The method according to claim 4, wherein
before in response to the target firmware being completely updated from the first version to the second version by the target program, acquiring the second version information of the target firmware, and sending the update end information to the BMC, the method further comprises: after sending the update start information to the BMC, switching the target firmware from the running state to the paused running state, switching the operating system from the paused running state to the running state, continuing to update the target firmware from the first version to the second version by the target program.

13. The method according to claim 1, wherein
in response to the target firmware being completely updated from the first version to the second version by the target program, acquiring second version information of the target firmware, and sending update end information to the BMC, comprises:
executing a second function that is preset in response to the target firmware being completely updated from the first version to the second version by the target program, wherein the second function is used for acquiring the second version information of the target firmware, and sending the update end information to the BMC.

14. The method according to claim 13, wherein
executing the second function that is preset in response to the target firmware being completely updated from the first version to the second version by the target program comprises:
executing, by the target firmware, the second function in response to the target firmware being completely updated from the first version to the second version by the target program, to acquire the second version information of the target firmware, and send the update end information to the BMC.

15. The method according to claim 14, wherein
executing, by the target firmware, the second function in response to the target firmware being completely updated from the first version to the second version by the target program, comprises:
in response to the target firmware being completely updated from the first version to the second version by the target program, switching the operating system from a running state to a paused running state, switching the target firmware from the paused running state to the running state, and executing the second function by the target firmware.

16. The method according to claim 14, wherein
executing, by the target firmware, the second function in response to the target firmware being completely updated from the first version to the second version by the target program, comprises:
in response to the target firmware being completely updated from the first version to the second version by the target program, triggering a target interruption, and executing the second function by the target firmware, wherein the second function is a function that is triggered to execute after the target interruption is triggered.

17. The method according to claim 14, wherein
the executing, by the target firmware, the second function comprises:
in response to the first version of the target firmware being copied from a first storage space to a second storage space, executing the second function by the first version of the target firmware stored in the second storage space, wherein the second storage space is a storage space in a memory of the server, the second function is used for reading the second version information from the first storage space and sending the update end information to the BMC, the first storage space is used for storing the second function, a current version of the target firmware and current version information of the target firmware; and when the current version of the target firmware is the second version, the current version information is the second version information.

18. The method according to claim 13, wherein
the executing the second function that is preset comprises:
executing a third part of a code of the second function, wherein the third part of the code of the second function is used for reading the second version information from the first storage space, the first storage space is used for storing a current version of the target firmware and current version information of the target firmware; when the current version of the target firmware is the second version, the current version information is the second version information; and
executing a fourth part of the code of the second function, wherein the fourth part of the code of the second function is used for sending the update end information to the BMC.

19-23. (canceled)

24. A method for generating a server log, comprising:
in response to starting to update target firmware in a server from a first version to a second version by a target program in an operating system of the server, receiving update start information sent by the target firmware, and recording received update start information in a target log, wherein the update start information comprises first version information, the first version information is description information of the first version, the first version information is version information obtained from a first storage space by executing a first function that is preset, the first storage space is configured to store the first function and a second function that is preset; and when starting to update the target firmware from the first version to the second version, the first storage space is further configured to store the first version and the first version information of the target firmware; and
in response to the target firmware being completely updated from the first version to the second version by the target program, receiving update end information sent by the target firmware, and recording received update end information in the target log, wherein the update end information comprises second version information, the second version information is description information of the second version, the second version information is version information obtained from the first storage space by executing the second function that is preset; and when the target firmware is completely updated from the first version to the second version, the first storage space is further configured to store the second version and the second version information of the target firmware, the second version of the target firmware is configured to replace the first version of the target firmware stored in the first storage space, and the second version information is used for replacing the first version information stored in the first storage space.

25. (canceled)

26. (canceled)

27. A computer-readable storage medium, wherein
the computer-readable storage medium stores a computer program, the computer program, when executed by a processor, implements the steps of the method according to claim 1.

28. An electronic device, comprising a memory, a processor, and a computer program stored on the memory and executable on the processor, wherein
the computer program, when executed by the processor, implements the steps of the method according to claim 1.
